(19) United States
(12) Patent Application Publication
(10) Pub. No.: US 2015/0212981 A1
(43) Pub. Date: Jul. 30, 2015

(54) PROVIDING PRINT VIEW OF DOCUMENT FOR EDITING IN WEB-BASED APPLICATION

(71) Applicant: Microsoft Corporation, Redmond, WA (US)

(72) Inventors: Robin Wakefield, Seattle, WA (US); Albert Chen, Seattle, WA (US)

(73) Assignee: Microsoft Corporation, Redmond, WA (US)

(21) Appl. No.: 14/166,690

(22) Filed: Jan. 28, 2014

(51) Int. Cl. G06F 17/21; G06F 17/30

(52) U.S. Cl. CPC G06F 17/212; G06F 17/30861

(57) ABSTRACT

Technologies are generally provided for enabling the viewing and editing the printed output of a document consistently in web-based application while a printed output of the document looks the same across different browsers as well as desktop client applications. A print view of a document handled by a server hosting the web-based application may be generated at the server, updated as edits are made to the document, and provided to a requesting browser or desktop client application such that the print view is consistent across multiple browsers and the client application.

### BACKGROUND

Ensuring that page layout in a document is preserved between desktop client software, web applications in multiple browsers, and printed output on paper may be a complicated challenge. Different browsers may have different core rendering logic, and each browser may lay out a page according to its respective rendering engine. Because of the variations between how browsers render documents, a document may be laid out differently on different browsers. Furthermore, a document may be laid out the same between a specific browser and in a traditional desktop application. However, differences due to rendering may also be manifested in printed content. For example, a document with text and a wrapped image may lay out with the image on the last line in browser A, with the image on the first line of the next page in browser B, and with the image on the second to last line and then a line of text underneath in desktop client A.

One approach to address the discrepancy in rendered or printed content is to create a layout engine that runs in a browser approximating a typically complex layout engine in desktop client software. While this approach may allow multiple browsers to display a document consistently, the approximation may frequently cause the content to lay out differently in the browser than in the desktop client. Additionally, because different browsers may have varying levels of standards support, documents printed from different browsers may lay out differently still.

### SUMMARY

This summary is provided to introduce a selection of concepts in a simplified form that are further described below in the Detailed Description. This summary is not intended to identify exclusively key features or essential features of the claimed subject matter, nor is it intended as an aid in determining the scope of the claimed subject matter.

Embodiments are directed to enabling the viewing and editing the printed output of a document consistently in web-based application while a printed output of the document looks the same across different browsers as well as desktop client applications. According to some example embodiments, a server may be used to generate the printed output and display on the web application. The view of the rendered document may be automatically updated on the web application as edits are made. The server may also ensure that the printed output of the document is the same across browsers and desktop clients.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example environment, where a web-based application may provide consistent print view of documents to client applications including browsers;

FIG. 2 illustrates an example client application user interface displaying a document to be edited and a print view of the same document adjacent to the displayed document;

FIG. 3 illustrates the example user interface of FIG. 2 following editing changes to the displayed document and refreshed print view;

FIG. 4 illustrates another example client application user interface displaying a document with page breaks indicating print view hints on the displayed document;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing print view of a document to client applications from a web-based application, according to embodiments.

### DETAILED DESCRIPTION

As briefly described above, print view of a document handled by a server hosting the web-based application may be generated at the server, updated as edits are made to the document, and provided to a requesting browser or desktop client application such that the print view is consistent across multiple browsers and the client application.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for a web-based service providing document processing services through client applications such as browsers. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

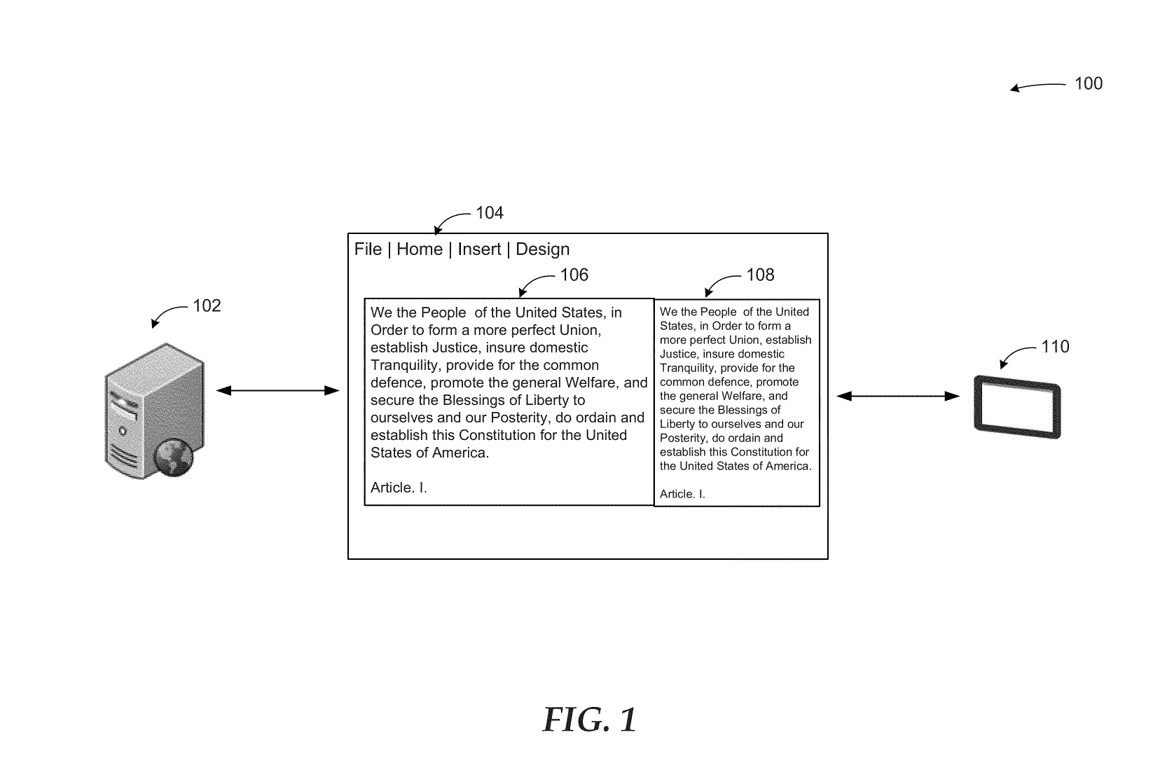

FIG. 1 illustrates an example environment, where a web-based application may provide consistent print view of documents to client applications including browsers.

As demonstrated in diagram 100, a hosted service such as a cloud-based word processing, spreadsheet, or similar service may be provided from one or more servers such as server 102 to client devices such as desktop computers, laptop computers, handheld computers, smart phones, and comparable ones. Tablet 110 is an example for the client devices. Users (or subscribers) of the service may access the service through a variety of applications such as desktop client applications (e.g., full application, mobile application), browsers, and so on.

The hosted service may enable users to view, edit, create, share, and publish different documents such as word processing documents, webpages, spreadsheet documents, presentation documents, emails, and similar one, to name a few. Users may view and edit a document 106 through the user interface 104 of their client application. As mentioned above, display of rendered documents may vary from one client application to another due to differences between rendering capabilities of the applications. Similarly, print views of the documents may also vary among different browsers and/or desktop client applications. In diagram 100, the print view 108 of the example document is shown next to the presented document 106.

A web-based service according to embodiments provides an intermediate step that can interpret a document in a common way across different endpoints (desktop client application, multiple browsers, printer, etc.) to ensure that the document is laid out consistently across each endpoint.

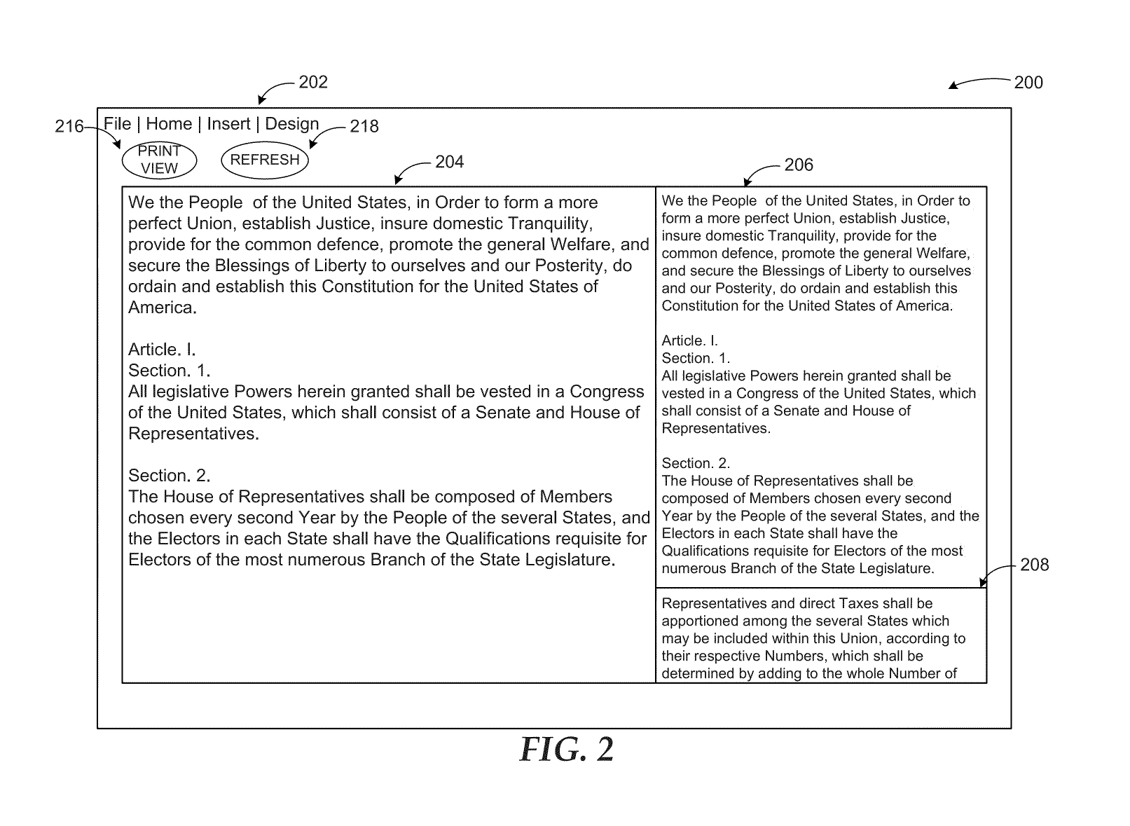

FIG. 2 illustrates an example client application user interface displaying a document to be edited and a print view of the same document adjacent to the displayed document.

Diagram 200 shows one configuration of presenting a document and corresponding print view, where the print view 206 is displayed adjacent (on right side) of the presented document 204. A user may be enabled to edit the displayed document 204 adding content, removing content, changing existing content such as moving textual content, graphical content, and images around.

Embodiments are not limited to the configuration shown in user interface 202 of FIG. 2, and may be implemented using other configurations, such as display location and format of the print view 206. Diagram 200 also includes controls 216 and 218. Control 216 may activate or deactivate the print view 206 (e.g., the document 204 may be expanded toward right if the print view 206 is deactivated). Control 218 may be used to refresh the print view manually. In some embodiments, the print view 206 may be updated (refreshed) in response to changes in the document 204 at regular intervals. Yet, in other embodiments, a user may be enabled to manually update the print view 206 through the control 218. Controls 216 and 218 may also be presented at any location on the user interface 202 in any shape or format. Additional controls to manage other features of the document and/or the print view may also be presented.

Diagram 200 further includes a page break 208 on the print view 206. The page break 108 may indicate to the user where a page ends and where another begins so that placement of textual content, graphical content, and images in relation to a layout of the page can be visualized by the user.

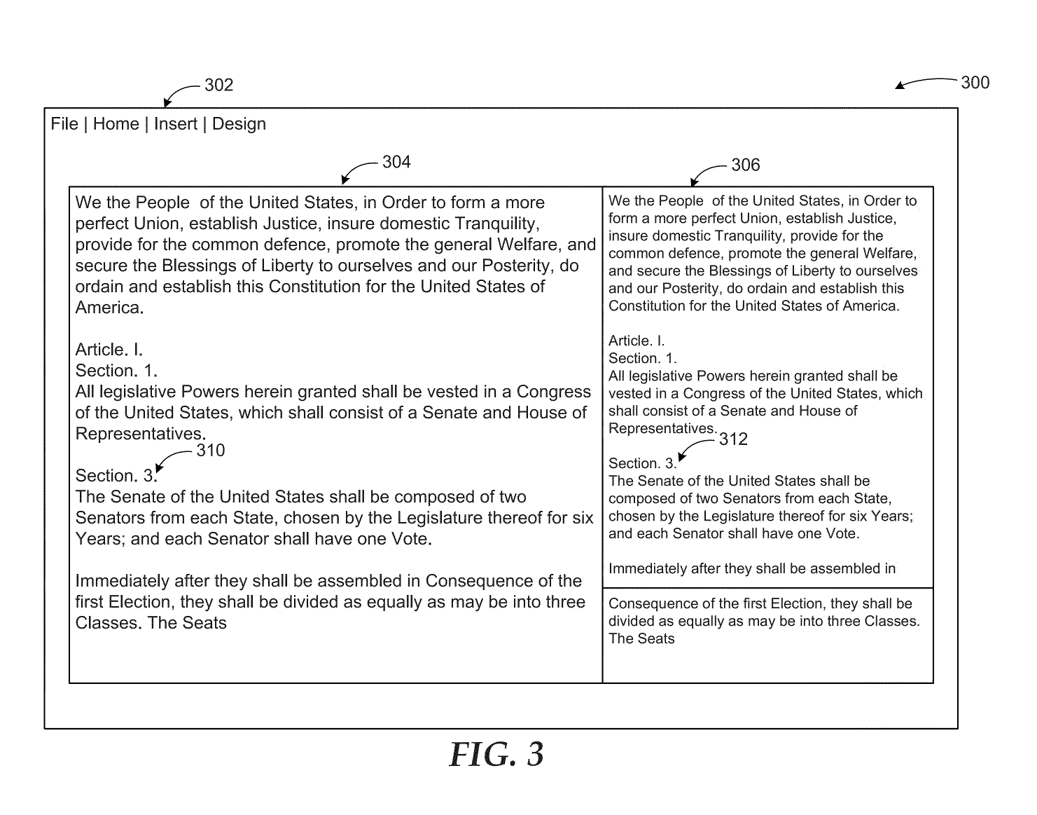

FIG. 3 illustrates the example user interface of FIG. 2 following editing changes to the displayed document and refreshed print view.

A user, viewing document 304 on the user interface 302, may edit the document, for example, inserting textual content 310. The edit changes may impact the print view 306 of the document and the print view 306 may be updated by the server hosting the application at regular intervals or by user action, for example, displaying the inserted textual content 312.

For consistent layout of the print view across different browsers and desktop client application, the server may place the inserted content appropriately within a page, for example, moving content before or after the inserted content such that the inserted content is placed at the same location relative to the page layout regardless of what type of application the user employs to view the document (or print).

While textual content is used as example in diagram 300, other forms of content may also be placed, moved, and otherwise modified for consistent print view. For example, a size, a placement of a table, or content around a table may be modified to ensure the table is consistently placed in relation to the page layout across different browsers (and/or printers).

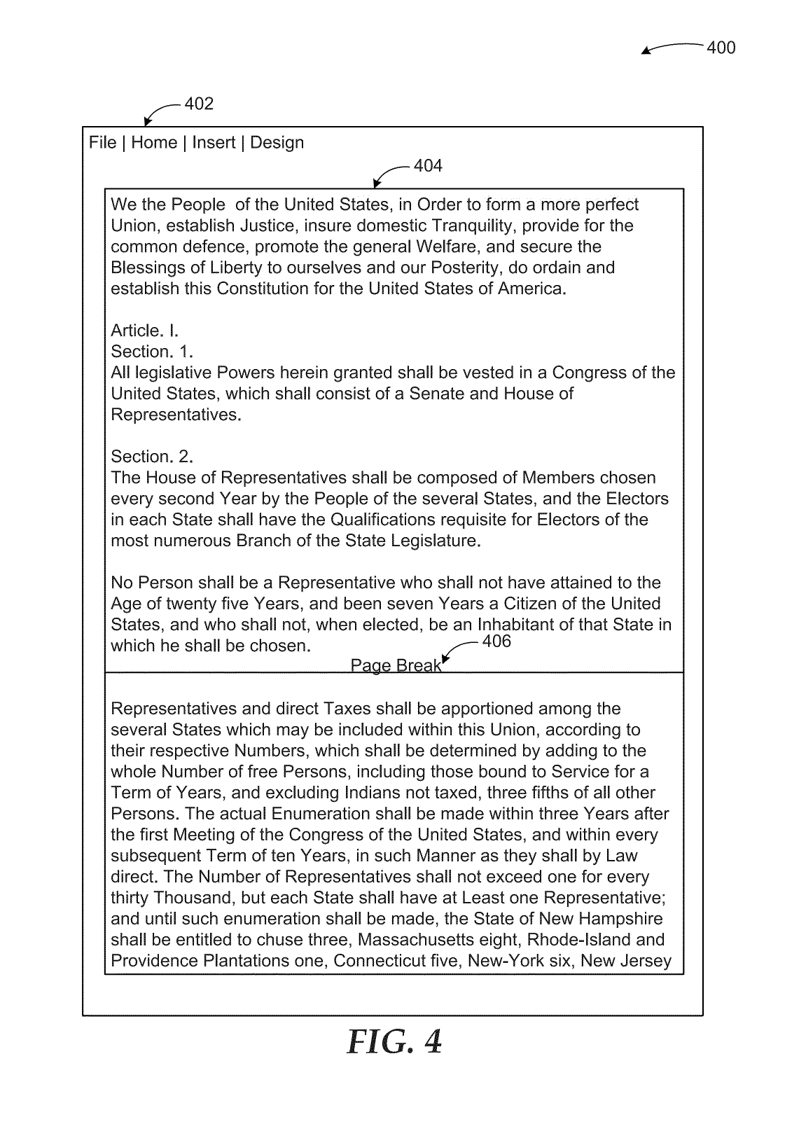

FIG. 4 illustrates another example client application user interface displaying a document with page breaks indicating print view hints on the displayed document.

Diagram 400 shows an alternative embodiment, where the print view may be presented to a user through a page break 406 on the edit view of the document 404 of the user interface 402. The page break 406 may allow a user to determine location and placement of content in relation to the layout of the page without the additional display of the print view. The location of the page break, as well as content around it (before and after) may be updated as edit changes are made to the document by the user.

In other embodiments, other indicators such as icons, graphical indicators along the edges of a page, etc. may also be used to visualize print view of a document without actually displaying the print view. Furthermore, print view may be updated at predefined intervals or upon user action at the server and the updated print view may be provided to client applications (e.g., browsers).

The example applications, devices, and modules, depicted in FIGS. 1-4 are provided for illustration purposes only. Embodiments are not limited to the configurations and content shown in the example diagrams, and may be implemented using other algorithms, configurations, client applications, service providers, and modules employing the principles described herein

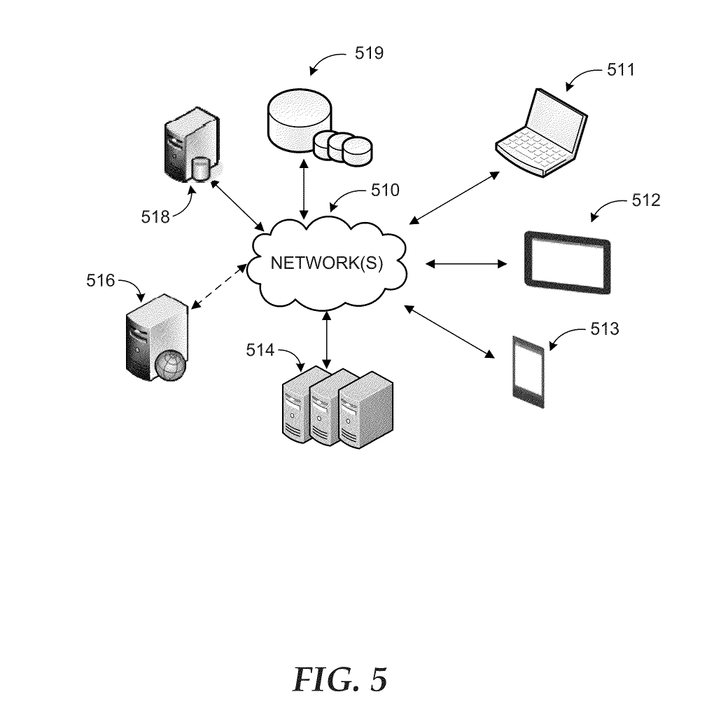

FIG. 5 is an example networked environment, where embodiments may be implemented. Viewing and editing the printed output of a document consistently in web-based application while a printed output of the document looks the same across different browsers as well as desktop client applications may be deployed in conjunction with hosted applications and services that may be implemented via software executed over one or more servers 514 or individual server 516. A hosted service or application may communicate with client applications on individual computing devices such as a handheld computer, a laptop computer 511, a tablet computer (or slate) 512, a smart phone 513 (‘client devices’) through network(s) 510 and control a user interface presented to users.

Client devices 511-513 may be used to access the functionality provided by the hosted service or application. One or more of the servers 514 or server 516 may be used to provide a variety of services as discussed above. Relevant data may be stored in one or more data stores (e.g. data store 519), which may be managed by any one of the servers 514 or by database server 518.

Network(s) 510 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to enable viewing and editing the printed output of a document consistently in web-based application while a printed output of the document looks the same across different browsers as well as desktop client applications. Furthermore, the networked environments discussed in FIG. 5 are for illustration purposes only. Embodiments are not limited to the example applications, modules, or processes.

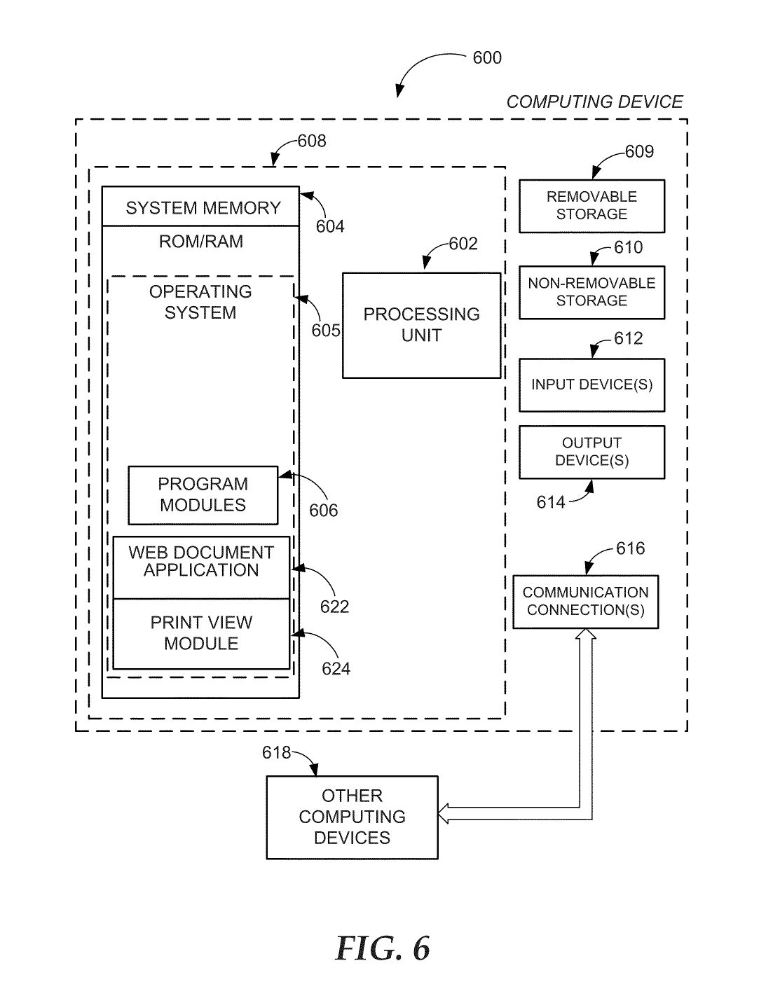

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any of the example devices discussed herein, and may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS®, WINDOWS MOBILE®, or WINDOWS PHONE® operating systems from MICROSOFT CORPORATION of Redmond, Wash. The system memory 604 may also include one or more software applications such as web document application 622 and print view module 624.

The print view module 624 may operate in conjunction with the hosted service or web document application 622 and provide viewing and editing the printed output of a document consistently in web-based application while a printed output of the document looks the same across different browsers as well as desktop client applications. Providing a consistent experience across different browsers and desktop client applications can improve the overall experience for the user by making improving efficiency and/or decreasing the amount of mental or physical exertion required to interact with the interface. Print view module 624 may also update print views in response to edit changes to the underlying document. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

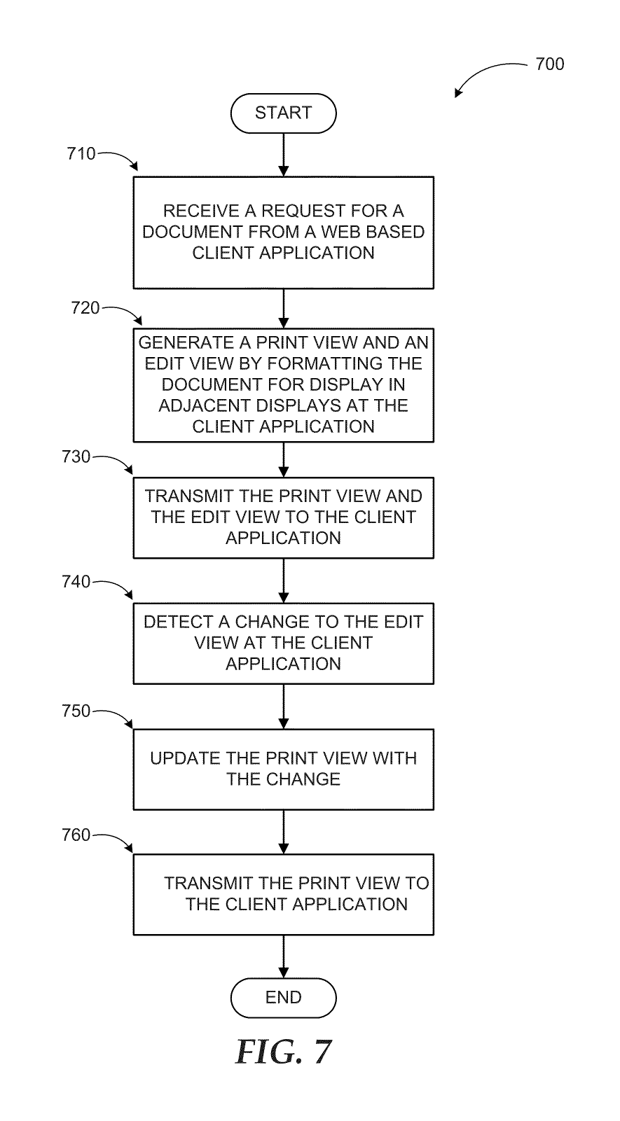

FIG. 7 illustrates a logic flow diagram for a process of providing print view of a document to client applications from a web-based application, according to embodiments. Process 700 may be implemented as part of a monitoring system or application.

Process 700 may begin with operation 710, where a request for a document may be received at a web-based application from a client application such as a browser or a desktop client application. At operations 720 and 730, the server may generate a print view of the document and provide the print view along with the document to the requesting client application such that the print view can be displayed along with an edit view of the document on a user interface of the client application.

At operation 740, the server may detect a change to the edit view of the document such as insertion, removal, or modification of document content. At operation 750, the server may update the print view in response to the detected change and transmit the updated print view to the client application at operation 760. By generating and updating the print view at the server and providing to requesting client applications, consistent display and/or printing of the document may be enabled.

The operations included in process 700 are for illustration purposes. Providing print view of a document to client applications from a web-based application according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part on a computing device for providing a print view of a document in a web-based application, the method comprising:
providing, at a server, the document for viewing and editing through a browser or a client application;
generating the print view of the document at the server;
providing the print view to the browser or the client application; and
updating the print view at the server in response to editing changes in the document through the browser or the client application.

2. The method of claim 1, further comprising:
enabling presentation of the print view on a user interface of the browser or the client application adjacent to the presented document.

3. The method of claim 1, further comprising:
enabling presentation of the print view on a separate user interface of the browser or the client application in addition to a user interface presenting document.

4. The method of claim 1, further comprising:
providing the print view to the browser or the client application such that the print view is displayed consistently across multiple browser user interfaces.

5. The method of claim 4, wherein the consistent display of the print view includes consistent placement of one or more of textual content, graphical content, or images in relation to each other.

6. The method of claim 4, wherein the consistent display of the print view includes consistent display of sizes of one or more of textual content, graphical content, or images.

7. The method of claim 4, wherein the consistent display of the print view includes consistent pagination of one or more of textual content, graphical content, or images.

8. The method of claim 1, further comprising:
providing the print view to the browser or the client application by enabling display of page breaks on a user interface of the browser or the client application displaying the document.

9. The method of claim 8, wherein locations of the page breaks are determined at the server to ensure consistent display of the print view across multiple browser user interfaces.

10. The method of claim 8, further comprising:
updating locations of the page breaks in response to edits made to the displayed document.

11. A computing device to provide a print view of a document in a web-based application, the computing device comprising:
a memory;
a processor coupled to the memory, the processor executing the web-based application, wherein the processor is configured to:
provide the document for viewing and editing through a browser or a client application;
generate the print view of the document;
provide the print view to the browser or the client application such that the print view is displayed consistently across multiple browser user interfaces; and
update the print view in response to editing changes in the document through the browser or the client application.

12. The computing device of claim 11, wherein the processor is further configured to:
enable presentation of the print view on a user interface of the browser or the client application adjacent to the presented document or a separate user interface of the browser or the client application in addition to a user interface presenting document.

13. The computing device of claim 11, wherein the processor is further configured to:
compute locations for page breaks to be displayed on the presented document such that one or more of textual content, graphical content, or images are displayed consistently in relation to each other across multiple browser user interfaces; and provide the page break locations to one or more browsers presenting the document.

14. The computing device of claim 11, wherein the processor is further configured to:
enable presentation of one or more controls on a user interface presenting the document, the controls associated with one or more of presentation of the print view, switching between the print view or an edit view, and deactivation of the print view.

15. The computing device of claim 14, wherein the controls include a control for refreshing the print view.

16. The computing device of claim 11, wherein the processor is configured to:
enable presentation of multiple pages of the document on a user interface presenting the print view.

17. The computing device of claim 11, wherein the computing device is a server hosting the web-based application.

18. A computer-readable memory device with instructions stored thereon to provide a print view of a document in a web-based application, the instructions comprising:
providing, at a server, the document for viewing and editing through a browser or a client application;
generating the print view of the document at the server;
providing the print view to the browser or the client application such that the print view is displayed consistently across multiple browser user interfaces;
enabling presentation of the print view on a user interface of the browser or the client application adjacent to the presented document or a separate user interface of the one of the browser and the client application in addition to a user interface presenting document; and
updating the print view at the server in response to editing changes in the document through the browser or the client application.

19. The computer-readable memory device of claim 18, wherein the instructions further comprise:
adjusting one or more of a size of a table, a placement of content around the table, or a location of the table in order to fit the table on a single page of the document in the print view.

20. The computer-readable memory device of claim 18, wherein the document is a word processing document, a spreadsheet, an email, a webpage, or a presentation document.
